(19) United States
(12) Patent Application Publication
(10) Pub. No.: US 2023/0165220 A1
(43) Pub. Date: Jun. 1, 2023

(54) COMPUTER-IMPLEMENTED METHOD, CONTROLLER, ARRANGEMENT AND MILKING SYSTEM FOR PREGNANCY DETECTION

(71) Applicant: DELAVAL HOLDING AB, Tumba (SE)

(72) Inventors: John M. CHRISTENSEN, Tumba (SE); Matt LUCY, Tumba (SE)

(21) Appl. No.: 17/921,868

(22) PCT Filed: Apr. 23, 2021
(86) PCT No.: PCT/SE2021/050377

§ 371 Date: Oct. 27, 2022

(30) Foreign Application Priority Data
Apr. 28, 2020 (SE) 2050483-3

(51) Int. Cl. A01K 29/00; A61D 17/00

(52) U.S. Cl. CPC A01K 29/005; A61D 17/006

(57) ABSTRACT

A computer-implemented method, a controller, an arrangement, and a milking system, wherein a point in time of an insemination of an animal is received, and a measurement of progesterone level is obtained in an analyte of the animal, and the animal is determined to be non-pregnant when the progesterone level of the obtained measurement is lower than a progesterone threshold limit, where the measurement is made within 11 days from the point in time of the insemination.

### TECHNICAL FIELD

This document discloses a computer-implemented method, a controller, an arrangement and a milking system. More particularly, a computer-implemented method, a controller, an arrangement and a milking system are described for detecting pregnancy/non-pregnancy of an inseminated animal.

### BACKGROUND

An animal is typically producing milk only after calving/when having a calf. On a dairy farm, it is thus important to continuously inseminate animals of the herd to fertilise them and thereby promote milk production.

On beef cattle, the milk is consumed by the calves. Non the less, it is important to continuously inseminate the animals to grow the calf crop.

The insemination is made when the animal is in heat. In some jurisdictions, it is allowed and common practice to trigger heat of the animal at any arbitrary moment by providing hormones according to an oestrus synchronisation programme. Hereby, heat may be synchronised between several animals in a group, which makes insemination rational, as all the animals of the group may be (artificially) inseminated at the same occasion.

In case an animal is not successfully inseminated, milk production is affected, as successful insemination and calving is a prerequisite for continuation of milk production. For beef cattle, meat production is affected correspondingly.

Thereby, it becomes desired to detect whether the insemination has been successful or not as early as possible after the insemination, in order to put the animal in heat again as soon as possible in case the animal has not become pregnant. Thereby, an iterated insemination of the animal may be made as soon as possible, minimising or at least reducing the time period to successful pregnancy, for ascertaining milk production.

On a farm where the animals are divided into different heat groups, it is desired to detect as soon as possible whether animals are pregnant, as animals having failed to become pregnant then could be scheduled for an iterated insemination as soon as possible in another heat group.

Successful insemination could be confirmed for example by measuring hormone level such as e.g., progesterone in milk/blood/urine of the animal, or by ultra-sound examination. However, in any case, successful pregnancy cannot be confirmed earlier than about 21-24 days after breeding.

The document “The use of milk progesterone assays for reproductive management”, IRM 9 by Dr. R. C. Rhodes, III of University of Rhode Island, published in 2005, describes early pregnancy detection of cows based on progesterone level measurements and stress the importance of early detection of non-pregnancy and identification of undiagnosed, untreated sub-fertile cows, for avoiding financial loss. A procedure for obtaining milk samples of an animal is described, stating that the time of sampling is critical, and that sampling is to be made between 21 and 24 days from breeding.

Another known manner of detecting non-pregnancy is to observe typical/known signs of the animal coming into a new period of heat after about 21 days. Pregnancy can also be determined by rectal palpation, ultrasound examination or blood analysis, however not before at least 28 days from insemination.

It would be desired to shorten the time period to pregnancy/non-pregnancy confirmation as much as possible, in order to be able to make an iterated insemination attempt as soon as possible, thereby minimising or at least reducing milk/meat production loss.

It would be desired to find a way to improve the assistance provided to the farmer in analysing his/her animals for early detection of pregnancy of animals, thereby enhancing calf breeding, milk production and/or meat production at the farm.

### SUMMARY

It is therefore an object of this invention to solve at least some of the above problems and enable early detection of pregnancy of an animal.

According to a first aspect of the invention, this objective is achieved by a computer-implemented method. The computer-implemented method comprises the step of receiving a point in time of an insemination of an animal. Also, the computer-implemented method comprises obtaining a measurement of progesterone level in analyte of the animal, which measurement is made within 11 days from the point in time of the insemination. Furthermore, the computer-implemented method also comprises determining that the animal is non-pregnant when the progesterone level of the obtained measurement is lower than a progesterone threshold limit.

Hereby, by exploiting the difference in progesterone level in an analyte such as milk and/or blood of animals that are pregnant and non-pregnant, respectively, during the first about 11 days from insemination, and take measurements of the progesterone level of the inseminated animal, a fast evaluation may be made whether the animal is pregnant or non-pregnant, much earlier than according to previously known methods. Thereby, in case the animal is considered non-pregnant, instant measures may be taken to re-inseminate the animal. The period of non-pregnancy of the animal may thereby be shortened, which will increase the milk/meat production of the farm, and the number of parturitions at the farm.

An analyte is a general term for a substance or chemical constituent that is subject of an analytical procedure. In this particular case, the analyte may be referring to a substance of the animal such as for example milk, blood, and/or possibly also urine, saliva, faeces or similar substance.

In an implementation of the computer-implemented method according to the first aspect, the analyte of the animal is milk.

Hereby, an analyte/milk sample from the animal may be extracted during milking and be used for progesterone level test, effortless and painless for the animal.

In another implementation of the computer-implemented method according to the first aspect, the analyte of the animal is blood.

By extracting a blood sample of the animal, pregnancy/non-pregnancy may be determined on an animal not producing milk, i.e. a heifer; or on beef cattle for which the milk is provided to the calves.

In an implementation of the computer-implemented method according to the first aspect, or any implementation thereof, the obtained measurement may be made within a time window which is longer than 4 days and shorter than 11 days.

In another implementation of the computer-implemented method according to the first aspect, or any implementation thereof, the obtained measurement may be made within a time window at 7 days.

In yet an implementation of the computer-implemented method according to the first aspect, or the first implementation thereof, the computer-implemented method comprises the step of determining to iterate a plurality of progesterone level measurements in analyte of the animal at a plurality of moments in time, within the time window. According to the implementation, a plurality of progesterone level measurements may be obtained. Also, it may be determined that the animal is non-pregnant when the progesterone level of each one of the obtained plurality of progesterone level measurements within the time window is lower than the progesterone threshold limit.

By making several measurements of the progesterone level and comparing them with the progesterone threshold limit, an increased validity of the pregnancy evaluation may be made.

In another implementation of the computer-implemented method according to the first aspect, or any implementation thereof, the computer-implemented method comprises scheduling the animal for hormone treatment according to an oestrus synchronisation programme when the animal is determined to be non-pregnant.

By getting the animal into heat again as soon as possible, a new insemination could be made, minimising the time period of non-pregnancy of the animal.

In a fourth implementation of the computer-implemented method according to the first aspect, or any implementation thereof, the computer-implemented method comprises sorting the animal into a separation zone when it has been determined that the animal is non-pregnant.

By opening a gate leading to a separation zone, as triggered when the animal is determined to be non-pregnant, an automatic sorting of non-pregnant animals may be made without necessarily requiring physical presence and/or intervention by the farmer. Thereby, working time of the farmer is saved.

In yet another implementation of the computer-implemented method according to the first aspect, or any implementation thereof, the computer-implemented method comprises alerting a farmer when the animal is determined to be non-pregnant.

By alerting the farmer concerning the pregnancy status of the animal, the farmer becomes aware of any animal being non-pregnant and could thereby take measures to re-inseminate the animal.

In another implementation of the computer-implemented method according to the first aspect, or any implementation thereof when the analyte is milk, the progesterone threshold limit is about 3-8 ng/ml progesterone in milk.

In another implementation of the computer-implemented method according to the first aspect, or any implementation thereof when the analyte is milk, the progesterone threshold limit is 5 ng/ml progesterone in milk.

In another implementation of the computer-implemented method according to the first aspect, or any implementation thereof, the computer-implemented method comprises determining that the animal is pregnant when the progesterone level of the obtained measurement exceeds the progesterone threshold limit.

By confirming that the animal is pregnant at an early stage, special treatment may be provided to the pregnant animal to avoid or reduce the risk of miscarriage, such as for example providing nutritious fodder, spacious resting area, etc.

According to a second aspect of the invention, this objective is achieved by a controller, configured to perform the computer-implemented method according to the first aspect, or any implementation thereof.

According to a third aspect of the invention, this objective is achieved by an arrangement configured to evaluate progesterone level in analyte of an animal. The arrangement comprises a controller according to the second aspect. The arrangement also comprises an input means, configured to receive a point in time of an insemination of the animal. In addition, the arrangement comprises a progesterone level measurement device, configured to measure a progesterone level of an analyte sample of the animal. Also, the arrangement comprises a sensor, configured to detect the result of the progesterone level measurement of the progesterone level measurement device. The arrangement furthermore comprises a memory, configured to store a progesterone threshold limit.

In a first implementation of the arrangement according to the third aspect when the analyte is blood, comprises a blood sample extractor configured to extract a blood sample from the animal and provide the extracted blood sample to the progesterone level measurement device.

According to a fourth aspect of the invention, this objective is achieved by a milking system. The milking system comprises an arrangement according to the third aspect wherein the analyte is milk. The milking system also comprises a milk sample extractor, configured to extract a milk sample from the animal during a milking operation and provide the extracted milk sample to the progesterone level measurement device.

By extracting milk of the animal during regular milking, the progesterone level in milk may be continuously surveyed by making measurements during milking occasions within about e.g. 11 days from the insemination, without any particular intervention by the farmer.

In an implementation of the milking system according to the fourth aspect, the milking system also comprises a database configured for storing information of animals of a herd, which information relates to insemination, pregnancy/non-pregnancy, and/or scheduled hormone treatment, associated with an identity reference of the respective animal.

By storing information concerning insemination, pregnancy, synchronisation group etc., associated with the identity reference of the animal, the farmer is assisted in keeping track of the successfulness of pregnancy related matters. Animals which are in particular difficult to get pregnant may be identified and sorted out, for example.

In yet another implementation of the milking system according to the fourth aspect, or the first implementation thereof, the milking system comprises an output device, configured to alert a farmer when the animal is determined to be non-pregnant.

In another implementation of the milking system according to the fourth aspect, or any implementation thereof, the controller of the arrangement according to the third aspect may be configured to perform the computer-implemented method according to the first aspect and the seventh implementation thereof. The milking system may also comprise a sorting gate, configured to separate the animal into a separation zone when the animal is determined to be non-pregnant.

By opening a gate leading to a separation zone, as triggered when the animal is determined to be non-pregnant, an automatic sorting of non-pregnant animals may be made without necessarily requiring physical presence and/or intervention by the farmer. Thereby, working time of the farmer is saved.

Other advantages and additional novel features will become apparent from the subsequent detailed description.

### FIGURES

Embodiments of the invention will now be described in further detail with reference to the accompanying figures, in which:

FIG. 1A illustrates an example of a milking system of a farm, according to an embodiment.

FIG. 1B illustrates an example of a milking system of a farm, according to an embodiment.

FIG. 2A illustrates examples of progesterone levels in milk in a pregnant animal and a non-pregnant animal, and a measurement made in a time window.

FIG. 2B illustrates examples of progesterone levels in milk in a pregnant animal and a non-pregnant animal, and measurements made in a time window.

FIG. 3 illustrates an example of likelihood of embryo loss over time as counted from the insemination

FIG. 4 illustrates an example of a milking station and a sorting gate, according to an embodiment.

FIG. 5 is a schematic illustration of a computer-implemented method according to an embodiment.

FIG. 6 is a schematic illustration of a milking system of a farm, according to an embodiment.

### DETAILED DESCRIPTION

Embodiments of the invention described herein are defined as a computer-implemented method, a controller, an arrangement and a milking system, which may be put into practice in the embodiments described below. These embodiments may, however, be exemplified and realised in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

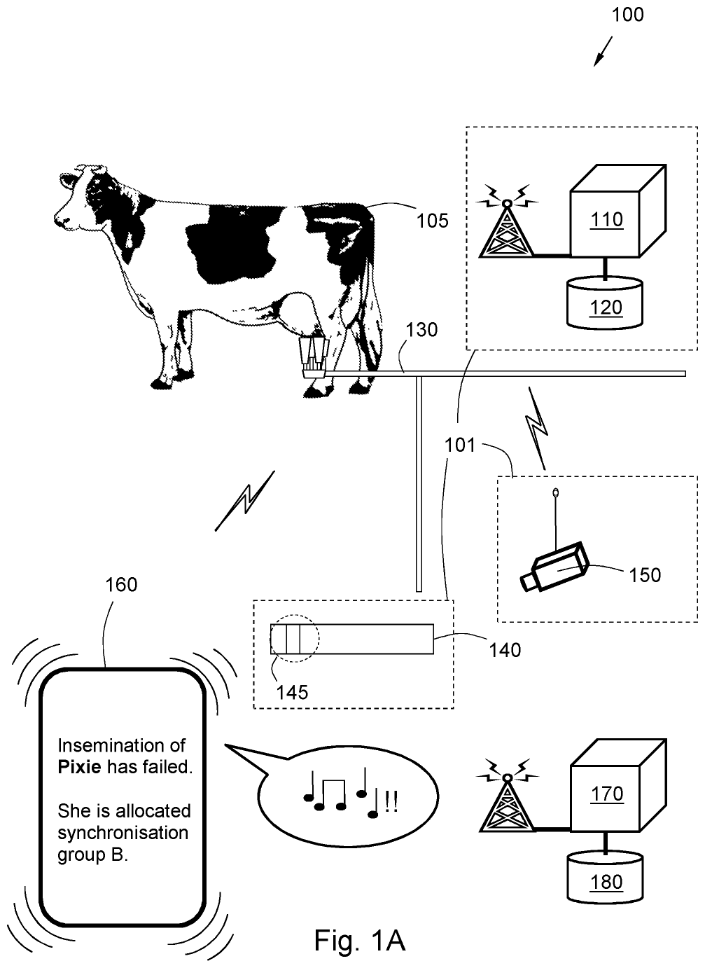

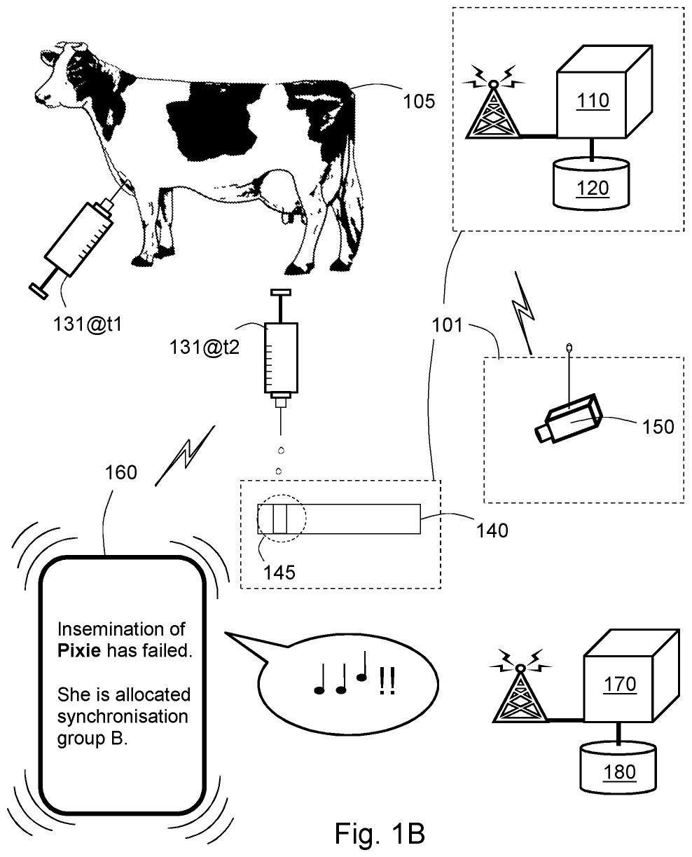

FIG. 1A illustrates a scenario of a milking system 100 of a dairy farm, while FIG. 1B illustrates an arrangement 101 configured to evaluate progesterone level in analyte of an animal 105, in this case the analyte is blood.

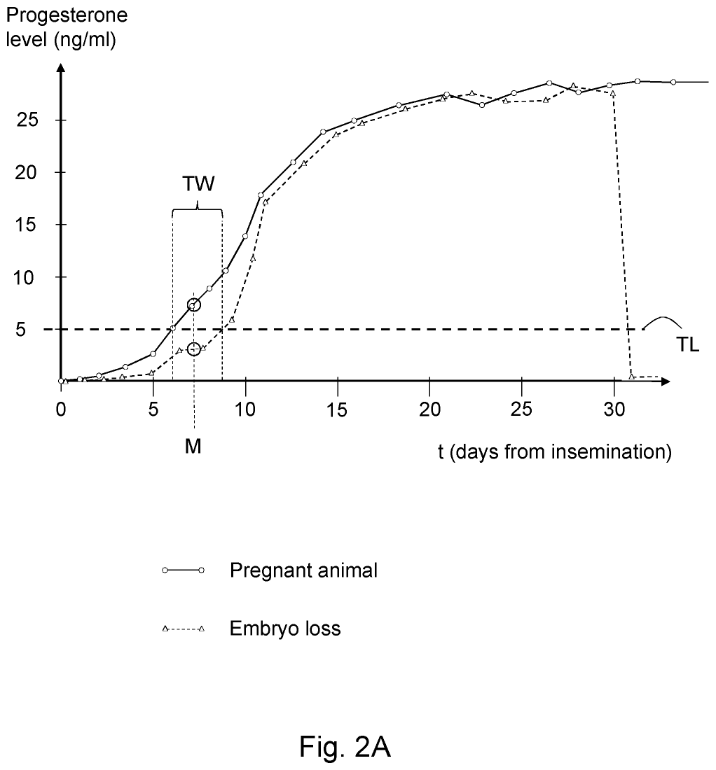

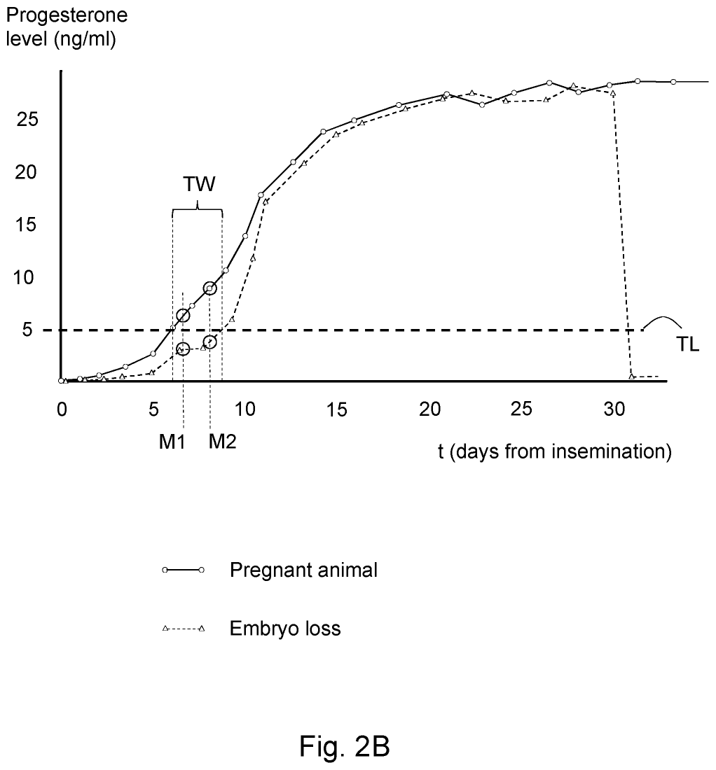

FIGS. 2A-B illustrate some examples of progesterone levels in an analyte, in this case milk, in a pregnant animal and a non-pregnant animal, respectively.

It has been observed the level of progesterone during the first about 10 days after insemination is critical for the successfulness of the insemination. In case the progesterone level stays below a threshold limit around about 5 ng/ml progesterone in milk for more than about five to six days+lag time (e.g. one day), it is possible to determine, with a relatively large likelihood that the insemination of the tested animal has failed and the animal is non-pregnant.

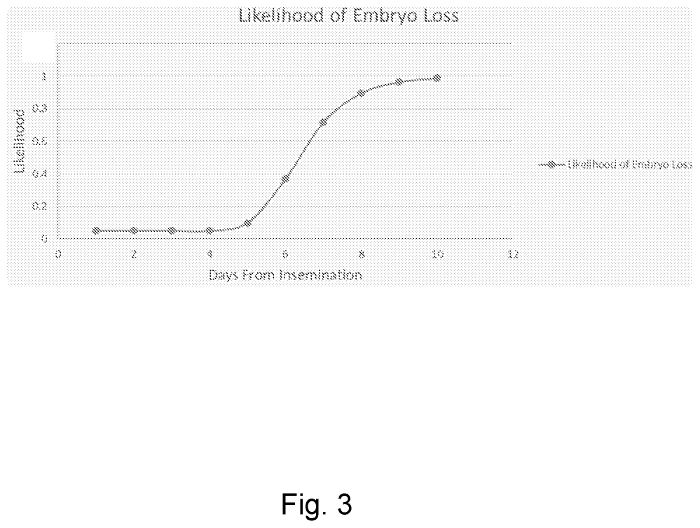

The embryo loss prediction (Risk None Pregnancy (RiskNP)) is a function of progesterone level since insemination. If the level stays below 5 ng/ml progesterone in milk more than five to six days+lag time (about one day) to increase the likelihood of non-pregnancy achieved, as indicated in the graph of FIG. 3.

It may hereby be predicted already after about 7-11 days whether the animal is pregnant or not. Detected failed insemination may in turn trigger an iterated insemination attempt of the animal, which leads to shorter time until pregnancy and thereby also stimulating milk/meat production.

The structural environment of the solution will firstly be discussed before going deeper into details of the solution.

The milking system 100 comprises an arrangement 101. The arrangement 101 is configured to evaluate progesterone level in analyte of the animal 105. The animal 105 may be comprised in a herd of dairy animals at the dairy farm.

“Animal” may be any arbitrary type of domesticated female milk producing and/or meat producing mammal such as cow, goat, sheep, horse, camel, dromedary, dairy buffalo, donkey, reindeer, yak, etc. (non-exhaustive list).

The analyte may be milk, as in the illustrated example, or blood of the animal 105.

The arrangement 101 comprises an input means 160, configured to receive a point in time of an insemination of an insemination of the animal 105. The input means 160 may comprise a mobile portable device, carried by the farmer/veterinarian engaged for the insemination. However, in other embodiments, the input means 160 may comprise a peripheral device that is configured to receive and send data to a controller 110, comprised in the arrangement 101. The input means 160 may comprise a mouse, keyboard, graphics tablet, image scanner, barcode reader, microphone, digital camera, webcam or similar means.

The arrangement 101 also comprises a progesterone level measurement device 140, configured to measure a progesterone level of an analyte sample of the animal 105. The progesterone level measurement device 140 may for example comprise a flow stick, prepared to indicate presence of progesterone at a certain level in an applied analyte sample.

The analyte sample may be extracted from the animal 105 and provided to the progesterone level measurement device 140 by a milk sample extractor 130 comprised in the milking system 100 when the analyte is milk. Hereby, milk samples may be extracted at the moment of regular milking of the animal 105 in some embodiments. In other embodiments, a milk sample may be obtained manually by the farmer from the evacuated milk of the animal 105.

In addition, the arrangement 101 comprises a sensor 150, configured to detect the result of a progesterone level measurement of the progesterone level measurement device 140. The sensor 130 may comprise a camera, video camera or similar type of visual sensor.

The arrangement 101 furthermore comprises a memory 120, configured to store a progesterone threshold limit, with which a sample progesterone level in analyte of a measurement may be compared by the controller 110.

When the animal 105 has been inseminated, the controller 110 receives information concerning a point in time of insemination of the animal 105. This information may be provided by the farmer via the input means 160, in some embodiments. The controller 110 may then obtain one or several progesterone level measurements of progesterone level in analyte of the animal 105, which measurement/-s has been made within 11 days from the point in time of the insemination. A comparison may then be made between the measurement and the progesterone threshold limit, which may be stored in and retrieved from the memory 120. Based on the made comparison, the controller 110 may determine that the animal 105 is non-pregnant when the progesterone level of the obtained measurement/-s is lower than the progesterone threshold limit.

In some embodiments, the milking system 100 may comprise a database 180 configured for storing information of animals 105 of the herd, which information relates to insemination, pregnancy/non-pregnancy, and/or scheduled hormone treatment, associated with an identity reference of the animal 105. Thereby, the milking system 100 may continuously monitor and keep track on the current pregnancy state of the animal 105 and the scheduled hormone treatment, or synchronisation group.

Also, the milking system 100 may comprise an output device 160, configured to alert a farmer when the animal 105 is determined to be non-pregnant. The farmer hereby becomes aware of the failed pregnancy of the animal 105 and may make an appropriate measure, such as for example manually sorting out the animal 105 into another synchronisation group.

Heat synchronisation, or oestrous synchronisation, involves manipulation of the female animals 105 oestrous cycle by hormone treatment so they can be bred at the same time. This brings various advantages. For example, the farmer does not have to constantly monitor and detect heat signs of animals 105 in the herd, which involves considerable labour in particular at a large farm. It also rationalises the work of artificial insemination, as the farmer could sequentially inseminate a plurality of animals 105.

It is however usually not desired to inseminate all animals at the farm simultaneously. A farm may have a herd of thousands of animals. To inseminate them all at the same day would bring a considerable ergonomic stress and exhaustion to the farmer/veterinarian.

A corresponding problem would emerge about 9 months later when all the successfully inseminated animals would give birth at about the same time, which also would be a problem. There may be several animals having issues during the calving and need manual assistance from the farmer/veterinarian at the same time.

For these reasons, the herd is typically divided into different synchronisation groups, where the animals within each synchronisation group are treated with hormones and inseminated at about the same time, while the different synchronisation groups are hormone treated/inseminated at distinct moments in time.

The oestrous synchronisation is targeting to bring the animals into heat within a certain time frame, which may vary in length between different programs from about 36 hours and up to several days. This is achieved through the use of one or more hormones according to an oestrus synchronisation programme. Hormones like for example progesterone, progestin, prostaglandin, or gonadotropin releasing hormone (GnRH) may be injected to the animal 105 in different synchronisation programs.

An example of an oestrus synchronisation programme (out of many programs) is the Select Synch scheme. When using Select Synch, GnRH is provided to the animals of the same synchronisation group on day 0. On day 7, Prostaglandin is provided to the animals of the synchronisation group, and the animals may then be inseminated yet some day or days later.

FIG. 1B illustrates a scenario wherein the analyte is blood. An analyte sample may be extracted from the animal 105 and provided to the progesterone level measurement device 140 by a blood sample extractor 131. At a first moment in time t1, the blood sample extractor 131 may extract blood of the animal 105 and provide the extracted blood sample to the progesterone level measurement device 140 at a second moment in time t2.

This may be made automatically in some embodiments, for example at a feeding station, when passing a passage to a feeding station or other location that the animal 105 regularly visits. Hereby, working time of the farmer is saved. Alternatively, the farmer may manually extract the blood sample from the animal 105.

The other elements of the arrangement 101 may be similar to the ones already presented in FIG. 1A, such as the controller 110, the input means 160, the progesterone level measurement device 140, the sensor 150, and/or the memory 120.

Returning to FIG. 2A, the respective progesterone levels during the first about 30 days after insemination of two inseminated animals are illustrated, wherein one animal is pregnant (solid line) and one animal is non-pregnant (dashed line).

It is noted that there is a difference in progesterone level in milk of the pregnant animal and the non-pregnant animal, in a time window TW, occurring about approximately 1 to 11 days after the insemination. The time window TW may be somewhat different for different types of animals, different breeds of animals, between different farms, etc. Within this time window TW, the progesterone level in milk of the non-pregnant animal is significantly lower than the progesterone level in milk of the pregnant animal. The reason may be that the embryo needs or utilises progesterone for successful development. It may alternatively be the other way around, i.e. that non-development or loss of the embryo causes the low progesterone level.

The solution utilises the observed difference in progesterone level for making an early detection of non-pregnancy. When the inseminated animal 105 is investigated for pregnancy, a measurement M may be made within the time window TW in some embodiments, for progesterone level of milk of the animal 105. In the illustrated embodiment, the measurement M is made about 7 days after insemination.

The measurement M may be compared with a threshold limit TL. The threshold limit TL may be between about 1-15 ng/ml progesterone in milk. The threshold limit TL may be set differently for different types of animals, different breeds of animals, between different farms, etc. In the illustrated embodiment, the threshold limit TL is set to 5 ng/ml progesterone in milk.

When the analyte is blood, the progesterone threshold limit TL may be set to a lower value, for example about 10% lower than for milk. Thus, in a non-limiting example, the progesterone threshold limit TL may be set to about e.g. 2.7-7.2 ng/ml progesterone in blood, for example 4.5 ng/ml progesterone in blood.

In case the measurement M exceeds the threshold limit TL, the animal 105 may be considered pregnant; otherwise the animal 105 may be considered non-pregnant.

FIG. 2B illustrates a scenario similar to the one illustrated in FIG. 2A, but wherein a plurality of measurements M1, M2 are made at different moments in time within the time window TW.

The progesterone level of the measurements M1, M2 are compared with the threshold limit TL and in case all the measurements M1, M2 are lower than the threshold limit TL, the animal 105 is considered non-pregnant. Otherwise, the animal 105 may be considered pregnant.

In case the animal 105 is considered non-pregnant, the animal 105 may be scheduled for hormone treatment according to an oestrus synchronisation programme. Hereby, early reiterated insemination may be made, thereby promoting calving and milk production on the farm.

FIG. 3 illustrates likelihood of embryo loss.

The embryo loss prediction (Risk None Pregnancy (RiskNP)) is a function of progesterone level since insemination. If the level stays below the threshold limit TL, such as e.g. 5 ng/ml progesterone in milk more than five to six days+lagtime (one day) to increase the likelihood of none pregnancy achieved.

The equation:

If ProgRaw is below LThresHR then

DFAI_{RiskNP}=SamplingTime−Insemination Date

RiskNP=Exp(−exp(−Rate*(DFAI_{RiskNP}−flex)))

Where

Rate=1.1

Flex=6

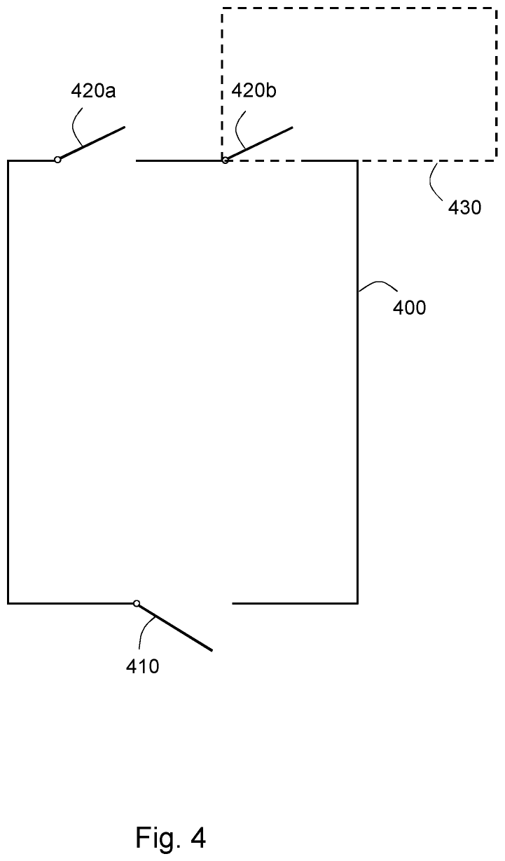

FIG. 4 illustrates an overview of a milking parlour 400 as regarded from above. An animal 105 may enter the milking parlour 400 via an entrance 410 and be milked by for example a milking robot or other milking unit. While milking the animal 105 in the milking parlour 400, the progesterone level of the extracted milk may be measured and compared with the threshold limit TL.

In case the animal 105 is considered to be pregnant according to the measurement, the animal 105 may be allowed to leave the milking parlour 400 via a first exit 420a, leading to either the resting section of the barn, or to the barn exterior where the animal 105 may stroll around in harmonic pasture, enjoying the grass.

In case the animal 105 is considered to be non-pregnant according to the measurement, the first exit 420a may remain closed and a second exit 420b may open, guiding the non-pregnant animal 105 to a separation zone 430, where it may join other animals of a synchronisation group for hormone treatment according to an oestrus synchronisation programme, and thereafter an iterated insemination.

Hereby, the animals that has a progesterone level below the threshold limit TL may be automatically sorted out and rescheduled for insemination as soon as possible automatically, without involving any manual selection or inspection by the farmer, which saves him/her working time that he/she instead could use for other purposes on the farm.

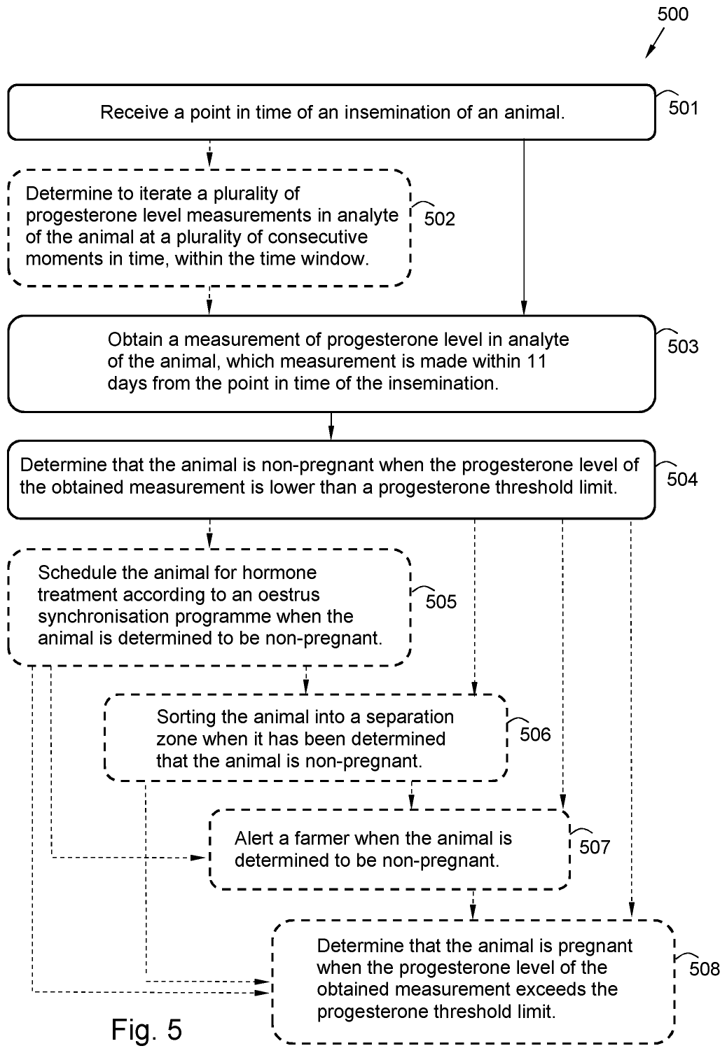

FIG. 5 illustrates an example of a computer-implemented method 500 in a controller 110 of an arrangement 101 configured to evaluate progesterone level in analyte of an animal 105. The purpose of the computer-implemented method 500 is to evaluate whether that the animal 105 is pregnant or non-pregnant by measuring progesterone level in the analyte of the animal 105. The analyte may be milk or blood of the animal 105, in different embodiments.

It hereby becomes possible to early detect a failed insemination of the animal 105 and schedule the animal 105 for a new insemination as soon as possible by putting the animal 105 into a synchronisation group.

In order to be able to evaluate pregnancy of the animal 105, the computer-implemented method 500 may comprise a number of steps 501-508. However, some of the described method steps 501-508 such as e.g. step 502 and/or 505-508 may be performed only in some embodiments. The described steps 501-508 may be performed in a somewhat different chronological order than the numbering suggests. The computer-implemented method 500 may comprise the subsequent steps:

Step 501 comprises receiving a point in time of an insemination of an animal 105.

The point in time of the insemination may be entered after the insemination by the farmer/veterinarian in some embodiments. The insemination of the animal 105 may alternatively be detected by a sensor, which may trigger a time determination, which information may be provided to the controller 110.

Step 502, which may be performed only in some embodiments, comprises determining to iterate a plurality of progesterone level measurements M1, M2 in analyte of the animal 105 at a plurality of moments in time, within a time window TW.

The time window TW may be for example 4-11 days, such as e.g. 5-8 days or at 7 days from insemination.

Step 503 comprises obtaining a measurement M of progesterone level in analyte of the animal 105, which measurement M is made within about 11 days from the point in time of the insemination.

In some embodiments, a plurality of progesterone level measurements M1, M2 may be obtained 503.

The obtained 503 measurement M may be made within a time window TW which is longer than 4 days and shorter than 11 days in some embodiments, such as for example longer than 5 days and shorter than 9 days. In some embodiments, the obtained 503 measurement M may be made within a time window TW at 7 days.

Step 504 comprises determining that the animal 105 is non-pregnant when the progesterone level of the obtained 503 measurement M is lower than a progesterone threshold limit TL.

The progesterone threshold limit TL may be about 3-8 ng/ml progesterone in milk, for example approximately 5 ng/ml progesterone in milk.

In other non-limiting examples wherein the analyte is blood, the progesterone threshold limit TL may be about 2.7-7.2 ng/ml progesterone in blood, for example approximately 4.5 ng/ml progesterone in blood.

It may be determined 504 that the animal 105 is non-pregnant when the progesterone level of each one of the obtained 503 plurality of progesterone level measurements M1, M2 within the time window TW is lower than the progesterone threshold limit TL.

By being able to make an early determination of failed insemination of the animal 105, appropriate measures may be taken for iterating insemination of the animal 105.

Step 505, which may be performed only in some embodiments, comprises scheduling the animal 105 for hormone treatment according to an oestrus synchronisation programme when the animal 105 is determined 504 to be non-pregnant.

Thus, the animal 105 may join another synchronisation group of animals, that are to be hormone treated and then inseminated sooner than any other synchronisation group at the farm.

Step 506, which may be performed only in some embodiments, comprises sorting the animal 105 into a separation zone 430 when it has been determined 504 that the animal 105 is non-pregnant.

In some embodiments, the sorting of the animal 105 may be made by opening a sorting gate 420b, operated by the controller 110. The opening of the sorting gate 420b may be triggered when determined 504 that the animal 105 is non-pregnant.

Step 507, which may be performed only in some embodiments, comprises alerting a farmer when the animal 105 is determined 504 to be non-pregnant.

The alert may be made via a message transmission to an output unit 160 of the farmer. The output unit 160 may be e.g., a cellular mobile telephone, a stationary or portable computing device, a computer tablet, a display, a pair of intelligent glasses, a smart contact lens, an augmented reality device, a smart watch or similar device having a user interface and wireless communication ability, or similar device.

Hereby, the farmer may become aware of the pregnancy status of the animal 105 and may initiate appropriate measures, depending on the obtained pregnancy status.

Step 508, which may be performed only in some embodiments, comprises determining that the animal 105 is pregnant when the progesterone level of the obtained 503 measurement M exceeds the progesterone threshold limit TL.

Hereby, successful insemination may be confirmed at an early stage.

When knowing that the animal 105 is pregnant, the animal 105 may be scheduled for special treatment and food/nutrition supply to promote development and growth of the embryo. Also, the calving may be predicted and a veterinarian may be pre-booked on that date, for example. The pregnant animal 105 may be sorted out into a particular restful part of the barn in some embodiments, thereby promoting harmonic growth of the embryo and sparing the animal 105 from distress caused by other animals and/or congestion.

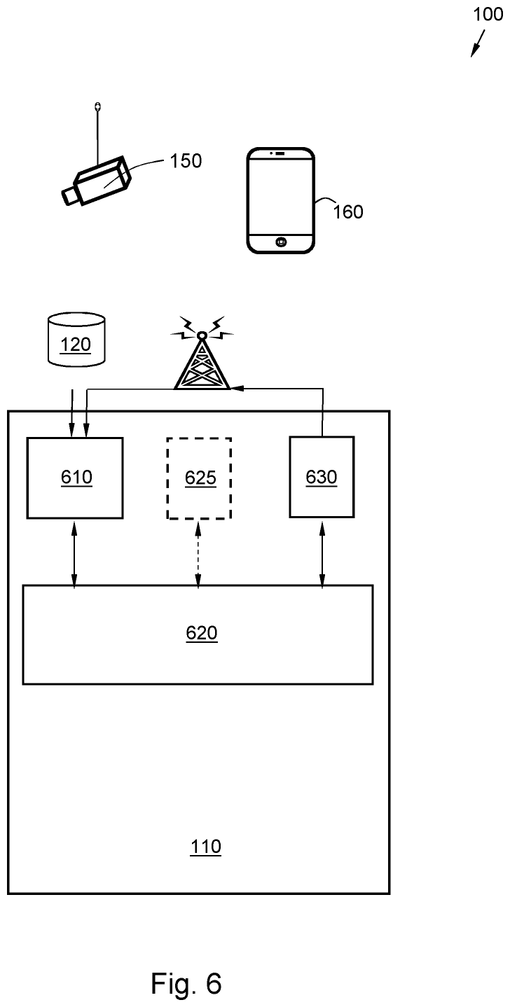

FIG. 6 illustrates a milking system 100, as has been illustrated in FIG. 1. The milking system 100 comprises an arrangement 101 configured to evaluate progesterone level in analyte of an animal 105, such as milk or blood in different embodiments. The arrangement 101 comprises a controller 110, configured to perform the computer-implemented method 500 according to any one of the method steps 501-508, as illustrated in FIG. 5 and discussed in the corresponding section of the specification.

Thus, the controller 110 is configured to receive a point in time of an insemination of an animal 105. Also, the controller 110 is configured to obtain a measurement M of progesterone level in analyte of the animal 105, which measurement M is made within 11 days from the point in time of the insemination. The controller 110 is in addition configured to determine that the animal 105 is non-pregnant when the progesterone level of the obtained measurement M is lower than a progesterone threshold limit TL.

In some embodiments, the controller 110 may be configured to determine to iterate a plurality of progesterone level measurements M1, M2 in analyte of the animal 105 at a plurality of moments in time, within the time window TW.

The controller 110 may in some embodiments be configured to obtain a plurality of progesterone level measurements M1, M2. Also, the controller 110 may be configured to determine that the animal 105 is non-pregnant when the progesterone level of each one of the obtained plurality of progesterone level measurements M1, M2 within the time window TW is lower than the progesterone threshold limit TL.

Furthermore, the controller 110 may be configured to schedule the animal 105 for hormone treatment according to an oestrus synchronisation programme when the animal 105 is determined to be non-pregnant.

The controller 110 may in addition be configured to sort the animal 105 into a separation zone 430 when it has been determined that the animal 105 is non-pregnant.

In further addition, the controller 110 may be configured to alert a farmer when the animal 105 is determined to be non-pregnant.

In further addition, the controller 110 may be configured to determine that the animal 105 is pregnant when the progesterone level of the obtained measurement M exceeds the progesterone threshold limit TL, in some embodiments.

The arrangement 101 also comprises an input means 160, configured to receive a point in time of an insemination of the animal 105, such as a portable communication device of the farmer, or similar device.

Also, the arrangement 101 comprises a progesterone level measurement device 140, configured to measure a progesterone level of an analyte sample of the animal 105.

The arrangement 101 in addition comprises a sensor 150, configured to detect the result of the progesterone level measurement M of the progesterone level measurement device 140.

The arrangement 101 also comprises a memory 120, configured to store a progesterone threshold limit TL. The progesterone threshold limit TL may be set to e.g. about 3-8 ng/ml progesterone per milk, such as for example 5 ng/ml progesterone per milk, when the analyte is milk.

The arrangement 101 may also, in some embodiments wherein the analyte is blood comprise a blood sample extractor 131, configured to extract a blood sample from the animal 105 and provide the extracted blood sample to the progesterone level measurement device 140.

The milking system 100 also comprises a milk sample extractor 130, configured to extract a milk sample from the animal 105 during a milking operation and provide the extracted milk sample to the progesterone level measurement device 140.

In some embodiments, the milking system 100 may comprise a database 180 configured for storing information of animals 105 of a herd, which information relates to insemination, pregnancy/non-pregnancy, and/or scheduled hormone treatment, associated with an identity reference of the respective animal 105.

The milking system 100 may also comprise an output device 160, configured to alert a farmer when the animal 105 is determined to be non-pregnant.

The controller 110 of the arrangement 101 which may be comprised in the milking system 100 may be configured to sort the animal 105 into a separation zone 430 when it has been determined that the animal 105 is non-pregnant. The milking system 100 may comprise a sorting gate 420b, configured to separate the animal 105 into a separation zone 430 when the animal 105 is determined to be non-pregnant.

The controller 110 comprises a receiver 610 configured to receive information from the database 120, and/or the sensor 150, and/or transceiver.

The controller 110 also comprises a processing circuitry 620 configured for performing various calculations for conducting a computer-implemented method 500 as illustrated in FIG. 5.

Such processing circuitry 620 may comprise one or more instances of a processing circuit, i.e. a Central Processing Unit (CPU), a processing unit, a processing circuit, a processor, an Application Specific Integrated Circuit (ASIC), a microprocessor, or other processing logic that may interpret and execute instructions. The herein utilised expression “processor” may thus represent a processing circuitry comprising a plurality of processing circuits, such as, e.g., any, some or all of the ones enumerated above.

Furthermore, the controller 110 may comprise a memory 625 in some embodiments. The optional memory 625 may comprise a physical device utilised to store data or programs, i.e., sequences of instructions, on a temporary or permanent basis. According to some embodiments, the memory 625 may comprise integrated circuits comprising silicon-based transistors. The memory 625 may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

Further, the controller 110 may comprise a signal transmitter 630. The signal transmitter 630 may be configured for transmitting signals via a wired or wireless communication interface to the output unit 160 of the farmer, possibly via a transceiver; and/or to the database 120, 180.

Furthermore, a computer program comprising instructions to perform the computer-implemented method 500 for determining that the animal 105 is non-pregnant or successfully pregnant.

The computer program mentioned above may be provided for instance in the form of a computer-readable medium, i.e. a data carrier carrying computer program code for performing at least some of the computer program steps, according to some embodiments when being loaded into the one or more processing circuitries 620 of the controller 110. The data carrier may be, e.g., a hard disk, a CD ROM disc, a memory stick, an optical storage device, a magnetic storage device or any other appropriate medium such as a disk or tape that may hold machine readable data in a non-transitory manner. The computer program may furthermore be provided as computer program code on a server and downloaded to the controller 110 remotely, e.g. over an Internet or an intranet connection.

The embodiments, or parts thereof, illustrated in FIG. 1, FIG. 2A, FIG. 2B, FIG. 3, FIG. 4, FIG. 5 and/or FIG. 6 may with advantage be combined with each other for achieving further benefits.

The terminology used in the description of the embodiments as illustrated in the accompanying drawings is not intended to be limiting of the described computer-implemented method 500, controller 110, arrangement 101, and/or milking system 100. Various changes, substitutions and/or alterations may be made, without departing from invention embodiments as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g. a processor may fulfil the functions of several items recited in the claims. The mere fact that certain measures or features are recited in mutually different dependent claims, illustrated in different figures or discussed in conjunction with different embodiments does not indicate that a combination of these measures or features cannot be used to advantage. A computer program may be stored/distributed on a suitable medium, such as an optical storage medium or a solid-state medium supplied together with or as part of other hardware, but may also be distributed in other forms such as via Internet or other wired or wireless communication system.

1. A computer-implemented method (500), comprising the steps of:
receiving (501) a point in time of an insemination of an animal (105);
obtaining (503), within a time window (TW) longer than four days and shorter than eleven days from a point in time of the insemination, a measurement (M) of progesterone level in analyte of the animal (105); and
determining (504) that the progesterone level of the obtained (503) measurement (M) is lower than a progesterone threshold limit (TL), and subsequently determining and recording a result that the animal (105) is non-pregnant.

2. The computer-implemented method (500) according to claim 1, wherein the analyte of the animal (105) is milk.

3. The computer-implemented method (500) according to claim 1, wherein the analyte of the animal (105) is blood.

4. (canceled)

5. The computer-implemented method (500) according to claim 1, wherein the obtained (503) measurement (M) is made at seven days from the point in time of the insemination.

6. The computer-implemented method (500) according to claim 1, comprising:
obtaining a plurality of progesterone level measurements (M1, M2) in the analyte of the animal (105) at a plurality of moments in time within the time window (TW),
wherein, in the determining step (504), the result that the animal (105) is non-pregnant is recorded after the progesterone level of each one of the obtained (503) plurality of progesterone level measurements (M1, M2) within the time window (TW) is determined to be lower than the progesterone threshold limit (TL).

7. The computer-implemented method (500) according to claim 1, further comprising:
scheduling (505) the animal (105) for hormone treatment according to an oestrus synchronisation programme after the animal (105) is determined (504) to be non-pregnant.

8. The computer-implemented method (500) according to claim 1, further comprising:
sorting (506) the animal (105) into a separation zone (430) after the animal (105) is determined (504) to be non-pregnant.

9. The computer-implemented method (500) according to claim 1, further comprising:
alerting (507) a farmer after the animal (105) is determined (504) to be non-pregnant.

10. The computer-implemented method (500) according to claim 1, wherein the analyte is milk, and the progesterone threshold limit (TL) is about 3-8 ng/ml.

11. The computer-implemented method (500) according to claim 1, wherein the analyte is milk, and the progesterone threshold limit (TL) is 5 ng/ml.

12. The computer-implemented method (500) according to claim 1, further comprising:
determining (508) and recording a result that the animal (105) is pregnant when the progesterone level of the obtained (503) measurement (M) exceeds the progesterone threshold limit (TL).

13. A controller (110), configured to perform functions of:
receiving (501) a point in time of an insemination of an animal (105);
obtaining (503), within a time window (TW) longer than four days and shorter than eleven days from a point in time of the insemination, a measurement (M) of progesterone level in analyte of the animal (105); and
determining (504) and recording a result that the animal (105) is non-pregnant when the progesterone level of the obtained (503) measurement (M) is lower than a progesterone threshold limit (TL).

14. An arrangement (101) configured to evaluate progesterone level in an analyte of an animal (105), the arrangement (101) comprising:
an input means (160), configured to receive a point in time of an insemination of the animal (105);
a progesterone level measurement device (140), configured to measure a progesterone level of an analyte sample of the animal (105);
a sensor (150), configured to detect a result of the progesterone level measurement (M) of the progesterone level measurement device (140);
a memory (120), configured to store a progesterone threshold limit (TL); and
a controller (110), configured to perform functions to:
receive (501) the point in time of the insemination of an animal (105);
obtain (503), within a time window (TW) longer than four days and shorter than eleven days from a point in time of the insemination, a measurement (M) of the progesterone level from the progesterone level measurement device (140); and
generate and store, in the memory, a determination (504) that the animal (105) is non-pregnant when the progesterone level of the measurement (M) obtained by the sensor (150) is lower than the progesterone threshold limit (TL).

15. The arrangement (101) according to claim 14, wherein the analyte is blood, and the arrangement (101) further comprises:
a blood sample extractor (131), configured to extract a blood sample from the animal (105) and provide the extracted blood sample to the progesterone level measurement device (140).

16. A milking system (100), comprising:
the arrangement (101) according to claim 14; and
a milk sample extractor (130), configured to extract a milk sample from the animal (105) during a milking operation and provide the extracted milk sample to the progesterone level measurement device (140),
wherein the analyte is milk.

17. The milking system (100) according to claim 16, further comprising:
a database (180) configured to store information of animals (105) of a herd, said information including data of at least one of insemination, pregnancy/non-pregnancy, and scheduled hormone treatment, associated with an identity reference of the animal (105).

18. The milking system (100) according to claim 16, further comprising:
an output device (160), configured to alert a farmer when the animal (105) is determined to be non-pregnant.

19. The milking system (100) according to claim 16, further comprising:
a sorting gate (420b), configured to separate the animal (105) into a separation zone (430) when the animal (105) is determined to be non-pregnant.

20. The controller (110) according to claim 13, further configured to perform the function of:
determining (508) and recording a result that the animal (105) is pregnant when the progesterone level of the obtained (503) measurement (M) exceeds the progesterone threshold limit (TL).

21. The arrangement (101) according to claim 14, wherein the controller is further configured to perform the function of:
determining (508) and recording a result that the animal (105) is pregnant when the progesterone level of the obtained (503) measurement (M) exceeds the progesterone threshold limit (TL).
